(19) United States
(12) Patent Application Publication
(10) Pub. No.: US 2009/0250345 A1
(43) Pub. Date: Oct. 8, 2009

(54) Microfluidic electroelution devices & processes

(75) Inventors: Matthew Jacob Powell, Westover, WV (US); Jifeng Chen, Morgantown, WV (US); Trust Tariro Razunguzwa, Morgantown, WV (US)

Correspondence Address: K&L GATES LLP, 535 SMITHFIELD STREET, PITTSBURGH, PA, 15222, US

(73) Assignee: Protea Biosciences, Inc.

(21) Appl. No.: 12/061,865

(22) Filed: Apr. 3, 2008

(51) Int. Cl. B01D 57/02

(52) U.S. Cl. 204/456; 204/606

(57) ABSTRACT

A microfluidic device for electroelution with sample collection decoupled from the electrophoretic field can generally comprise a channel having a first fluid pathway in fluid communication with a second fluid pathway, the first fluid pathway can comprise a first port in fluid communication with a second port, and a receptacle intermediate the ports, the second fluid pathway can comprise an inlet in fluid communication with an outlet, the first and second ports can be associated with first and second electrodes, respectively, such that the electrodes can create an electrophoretic field across the receptacle, and the channel can be configured to create a pressure drop from the first fluid pathway towards the second fluid pathway that encourages the electroeluted sample to flow towards the second fluid pathway.

### BACKGROUND

The present invention is related to the field of electroelution devices and processes, and in particular, microfluidic devices and processes for electroelution with sample collection decoupled from the electrophoretic field.

A fundamental difficulty in biochemistry, genetics, and molecular biology is the ability to reproducibly and efficiently identify and recover electrophoretically separated macromolecules following acrylamide gel electrophoresis. Sodium dodecyl sulfate-polyacrylamide gel electrophoresis (SDS-PAGE) is widely utilized as a preparative and analytical technique for the separation of proteins and other macromolecules, e.g., nucleic acids, antigens, and antibodies. Many techniques exist in the art to identify and recover proteins from an acrylamide gel. Most common techniques rely on diffusion or elution to extract the proteins from the acrylamide gel. For example, electroelution is a technique whereby proteins are electrophoretically removed from the acrylamide gel. In electroelution, an SDS-PAGE gel can be treated with a stain, e.g., Coomassie Brilliant Blue or SYPRO orange, to allow the visualization of proteins previously separated by SDS-PAGE. A gel band or spot containing the proteins of interest can be excised from the gel matrix and placed in an elution apparatus. The elution apparatus can create an electrophoretic field across the gel spot such that the proteins are electrophoretically eluted from the gel spot. The electroeluted proteins can be collected for further analysis or sequencing.

However, current electroelution procedures are generally inefficient and non-reproducible for a variety of reasons. For example, most procedures are time consuming because the electroelution apparatus is typically only able to elute a limited number of samples in a given time period. In addition, proteins can adsorb onto the surfaces of the electroelution apparatus or resorb onto the gel during the electroelution process. Furthermore, the overall efficiency and reproducibility of most electroelution procedures are reduced by losses of the sample during extraction and collection, and by contamination of the sample during transport and handling.

However, recent advances in miniaturization have led to the development of microfluidic systems that are designed, in part, to perform a multitude of chemical and physical processes on a microscale level. Microfluidic devices are generally fabricated on a substrate having a system of microstructures, e.g., microchannels and microchambers. Such microfluidic devices can have an internal volume of less than one microliter and the length scale of these channels is typically on the micron or submicron scale, i.e., having at least one cross-sectional dimension in the range from about 0.1 micron to about 500 microns. Microfluidic electroelution devices may offer faster response times and provide precise control over small volumes of fluid by collecting and concentrating many samples in parallel. Such microfluidic devices could enable the development of electroelution devices and processes that increase reproducibility and reliability by reducing sample processing time and sample degradation.

Accordingly, there is a need for microfluidic electroelution devices and processes that reproducibly and efficiently extract electrophoretically separated intact proteins from acrylamide gels.

### SUMMARY

An embodiment of a microfluidic electroelution module with sample collection decoupled from the electrophoretic field can generally comprise a channel having an inlet and an outlet, a receptacle in fluid communication with the channel intermediate the inlet and outlet, a first port and a second port in fluid communication with the channel, the second port positioned intermediate the receptacle and outlet, the receptacle located between the first and second ports, the first and second ports adapted to receive a first electrode and a second electrode, respectively, such that the electrodes will complete an electrical circuit when fluid is present in the channel to create the electrophoretic field across the receptacle when power is applied to the electrodes, and a flow restricting feature and/or a flow enhancing feature in fluid communication with the channel intermediate the second port and outlet such that fluid flow in the channel towards the outlet is encouraged and fluid flow in the channel towards the second port is discouraged. In further embodiments, the microfluidic modules can further comprise a sorbent material, e.g., a monolith or packed bed, in the channel intermediate the second port and the outlet such that the sorbent material is decoupled from the electrophoretic field created between the electrodes. In still further embodiments, the microfluidic module can be integrated onto a microfluidic chip.

An embodiment of a method of electroelution with sample collection decoupled from the electrophoretic field can generally comprise providing a first fluid pathway in fluid communication with a second fluid pathway, associating a sample having at least one macromolecule species of interest with the first fluid pathway, e.g., positioning a gel spot containing the species of interest in the receptacle, providing an elution liquid in the first and second fluid pathways, creating an electrophoretic field in the first fluid pathway, electrophoretically separating the species of interest from the sample by the electrophoretic field, and causing the species of interest to flow from the first fluid pathway toward the second fluid pathway by using a flow restricting feature and/or a flow enhancing feature. In further embodiments, the method can further comprise collecting the electroeluted species on a sorbent material, e.g., a monolith or packed bed, in the second fluid pathway, and processing, e.g., rinsing, desalting, purifying, and/or concentrating, the species collected on the sorbent material, and/or removing the collected species from the sorbent material.

An embodiment of a microfluidic module for electroelution with sample collection decoupled from the electrophoretic field can generally comprise a channel having a first fluid pathway in fluid communication with a second fluid pathway, the first fluid pathway comprising a first port in fluid communication with a second port, and a receptacle adapted to receive therein a sample containing at least one macromolecule species of interest, the receptacle in fluid communication with the first port, the second fluid pathway comprising an inlet in fluid communication with an outlet, wherein the first port is associated with a first electrode and the second port is associated with a second electrode such that the electrodes will create an electrophoretic field across the receptacle when fluid is present in the channel and power is applied to the electrodes, wherein the channel is configured to create a pressure drop from the first fluid pathway towards the second fluid pathway when fluid is present in the channel, and wherein the pressure drop encourages the electroeluted species of interest to flow from the first fluid pathway toward the second fluid pathway. In further embodiments, the pressure drop can be created by the relatively large volumes and column height of fluid in the reservoirs in the first fluid pathway compared to the volume and column height of fluid in the outlet reservoir.

An embodiment of a method of electroelution with sample collection decoupled from the electrophoretic field can generally comprise providing a first fluid pathway in fluid communication with a second fluid pathway, associating a sample having at least one macromolecule species of interest with the first fluid pathway, providing an elution liquid in the first and second fluid pathways, creating a pressure drop from the first fluid pathway towards the second fluid pathway, creating an electrophoretic field in the first fluid pathway, electrophoretically separating the species from the sample by the electrophoretic field, and wherein the pressure drop causes the species to flow from the first fluid pathway toward the second fluid pathway. In further embodiments, the method can further comprise the step of collecting the species on a sorbent material, e.g., a monolith or packed bed, in the second fluid pathway for further processing, e.g., rinsing, desalting, purifying, and/or concentrating, and/or removing the collected species from the sorbent material.

### BRIEF DESCRIPTION OF THE DRAWING FIGURES

A more complete understanding of the microfluidic electroelution devices and processes can be obtained by considering the following description in conjunction with the accompanying drawing figures in which like reference numbers refer to like elements, in which:

FIG. 1 is a schematic view of an embodiment of a microfluidic module;

FIG. 2 is a schematic view of an embodiment of a microfluidic module;

FIG. 3A is a partial rear view of an embodiment of a microfluidic device;

FIG. 3B is a front view of an embodiment of a microfluidic device;

FIG. 4A is a schematic view of an embodiment of a microfluidic module;

FIG. 4B is a schematic view of an embodiment of a microfluidic module;

FIG. 5A is a partial rear view of an embodiment of a microfluidic device; and

FIG. 5B is a front view of an embodiment of a microfluidic device.

### DESCRIPTION OF CERTAIN EMBODIMENTS

The term “microfluidic” as used herein describes structures or devices through which a fluid is capable of being passed or directed, wherein one or more of the dimensions is less than about 500 microns, e.g., depth, width, length, diameter, etc. In the devices of the present invention, the microstructures can have at least one cross-sectional dimension between about 0.1 microns and 250 microns, and often between about 0.1 microns and 100 microns.

The term “microstructure” as used herein describes microfluidic structures, e.g., “microchannels” and “microchambers” or any combination thereof. A microchannel can have at least one dimensional feature that is at least about 1 micron but less than about 500 microns in size. The term “channel” as used herein describes a microchannel. During operation, microchannels and microchambers may contain fluids passing therethrough.

The term “microfluidic chip” and “microfluidic device” as used herein refers to at least one substrate having microfluidic structures contained therein or thereon.

The microfluidic electroelution devices of the present invention can be typically constructed using one or more substrates. Substrates are typically made from a transparent material to aid observation, however non-transparent materials can be used. Suitable transparent substrate materials can include glass, polymeric, ceramic, metallic, silica-based, and composite materials, as well as any combination thereof. Examples of polymeric materials typically used include polystyrene, polypropylene, polyethylene, acrylonitrile butadiene styrene, polycarbonate, polymethyl methacrylate, cyclic olefin copolymer, polyester, polyimide, polyamide, or other acrylics, or any combination thereof. In the case of conductive or semi-conductive substrates, a chemical treatment should be applied to the microfluidic structures to provide a substrate with a near-neutral or neutral surface charge and eliminate bulk electroosmotic flow.

The microfluidic electroelution devices of the present invention typically comprise a system of microstructures, e.g., microchannels and microchambers, to transport fluids into, out of, and onto the various structures within the microfluidic devices, or any combination thereof. The microstructures can be prepared on substrates using standard manufacturing techniques. For example, lithographic techniques may be employed in fabricating glass, quartz or silicon substrates. In addition, photolithographic masking, plasma or wet etching and other semiconductor processing technologies can be used. Alternatively, micromachining methods, such as laser ablation, micromilling, and the like may be employed. Similarly, well known manufacturing techniques may also be used for polymeric substrates, e.g., compression molding, stamp molding, and injection molding, casting or embossing, and the like. For example, microchannels can be prepared by compression molding and microchambers can be prepared by using a diamond tipped drill, such as a microdrill. In order to provide fluid and/or control access to the microstructures, a series of reservoirs or ports in fluid communication with the microstructures can be provided in at least one of the substrates.

In various embodiments of the present invention, microfluidic devices include two substrates, e.g., a cover substrate and a base substrate, which are bonded together. The cover substrate and the base substrate can be bonded together by adhesive bonding, cohesive bonding, thermal bonding, mechanical bonding or any combination thereof. The bonding of the substrates provides regions for containing microstructures, e.g., a system of microchannels and microchambers, in both the base substrate and/or the cover substrate. When bonded together, the spatial arrangement of the microfluidic structures in the cover substrate are typically designed to be in fluid communication with the regions containing the microfluidic structures in the base substrate.

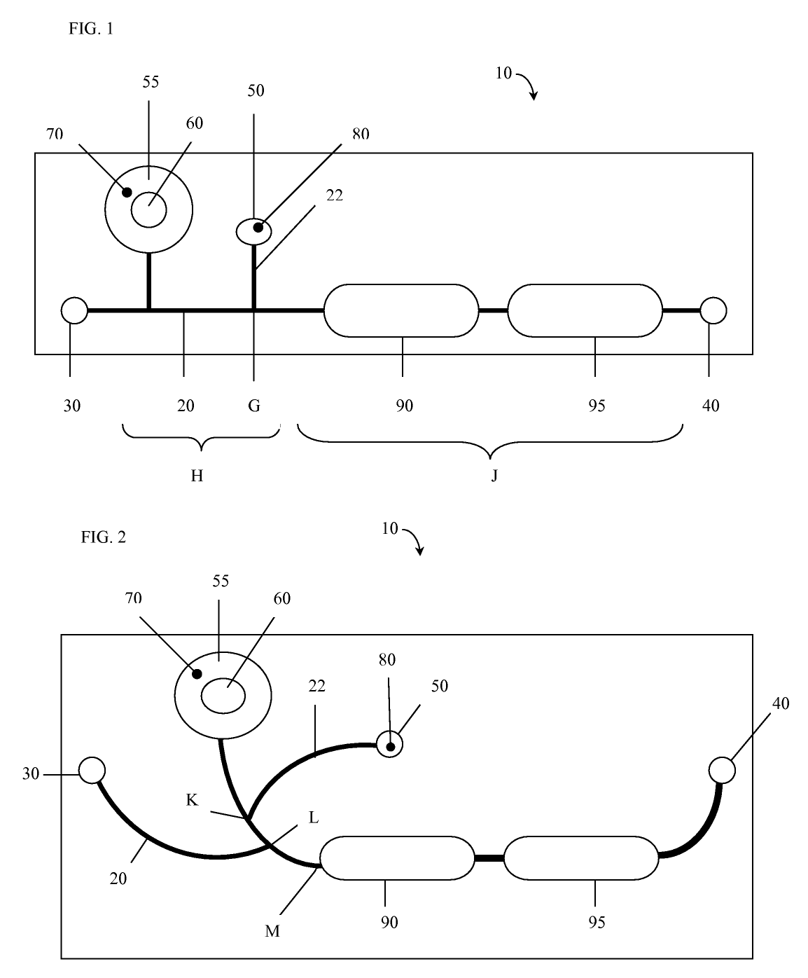

Referring to FIGS. 1 and 2, embodiments of microfluidic electroelution modules 10 with sample collection decoupled from the electrophoretic field can generally comprise a channel 20 having an inlet 30 and an outlet 40, a first port 60 and a second port 50 in fluid communication with the channel 20, the first port 60 intermediate the inlet 30 and outlet 40, a receptacle 60 in fluid communication with the channel 20 intermediate the inlet 30 and outlet 40, the second port 50 intermediate the receptacle 60 and outlet 40, the receptacle 60 located between the first 60 and second 50 ports, the first 60 and second 50 ports adapted to receive a first electrode 70 and a second electrode 80, respectively, such that electrodes 70, 80 will complete an electrical circuit when the electrodes 70, 80 and fluid is present in the channel 20 to create the electrophoretic field across the receptacle 60 when power is applied to electrodes 70, 80, and a flow restricting feature and/or a flow enhancing feature in fluid communication with the channel 20 intermediate the second port 50 and outlet 40 such that fluid flow in the channel 20 towards the outlet 40 is encouraged and fluid flow in the channel 20 towards the second port 50 is discouraged. The first port 60 can further comprise the receptacle 60.

In further embodiments, the flow restricting feature can be a branch channel 22 intermediate the second port 50 and the channel 20 such that the branch channel 22 has a smaller diameter than the channel 20 to discourage fluid flow towards the second port 50. The branch channel 22 can connect the second port 50 to the channel 20 at a junction G. A flow restrictor (not shown) can be positioned in the branch channel 22 to further discourage flow thereinto. In certain embodiments, the flow enhancing feature can be a microchamber 90 having at least one cross-sectional dimension or diameter greater than the channel 20 intermediate the branch channel 22 and the outlet 40 such that fluid flow towards the outlet 40 is encouraged.

In further embodiments, the microfluidic electroelution modules 10 can further comprise a first reservoir 55 in fluid communication with the first port 60. The first reservoir 55 can further comprise the receptacle 60. The first electrode 70 can be associated with the first reservoir 55. A sample or gel spot (not shown) containing at least one macromolecule species of interest can be positioned in the receptacle 60. The electrodes 70, 80 can create an electric field across the gel spot from the first electrode 70 towards the second electrode 80 such that the species electrophoretically migrate from the gel spot into the fluid present in the channel 20, e.g., an elution liquid or a buffer solution. The electrodes 70, 80 can be conventional, such as a simple conductor connected to a source of electricity. Furthermore, in accordance with the present invention, the flow restricting features, e.g., branch channel 22, discourage the migration of the electroeluted species towards the second electrode 80 and the flow enhancing features, e.g., microchamber 90, encourage the migration of the electroeluted species towards the outlet 40.

In still further embodiments, the microfluidic electroelution modules 10 can have a sorbent material 95 that collects and/or concentrates the electroeluted species in the channel 20 intermediate the second port 50 and the outlet 40 such that the sorbent material 95 is decoupled from the electrophoretic field created between the electrodes 70, 80. The sorbent material 95 can be a porous polymer monolith, a packed bed, or other suitable materials that act as chromatographic and/or extraction systems. The chromatographic and/or extraction systems provided by the sorbent material 95 can include partition chromatography, adsorption chromatography, ion exchange and ion chromatography, size exclusion chromatography, affinity chromatography, and chiral chromatography. Surprisingly, the collection and/or concentration of the electroeluted species by the sorbent material 95 is substantially improved by decoupling the sorbent material 95 from the electrophoretic field and decoupling the direction of fluid flow from the electrophoretic field.

A porous polymer monolith refers to highly cross-linked monolithic porous polymer materials that permit fluid communication through the pores. A porous polymer monolith can be functionalized to have chemical moieties on the surfaces of its pores that are capable of interacting and/or bonding to macromolecules or other analytes contacting or passing through its pores. A functionalized porous polymer monolith can be prepared by including a polymerizable functionalized monomer in a reaction mixture for preparing the porous polymer monolith or post-functionalizing the porous polymer monolith after it is formed. The functionalized monomer can be selected to contain a functional group that directly binds or interacts to a particular analyte or probe compound capable of selectively binding to or interacting with the particular analyte. For example, the functionalized porous polymer monolith can have reversed phase (C₄, C₈, or C₁₈) or ion exchange chemistry.

The porous polymer monolith can be formed integrally in the channel 20 or microchamber 95 by photoinitiated or thermally initiated in situ polymerization. A method of making a porous polymer monolith within a channel of a microfluidic module can comprise copolymerization of a monomer, a crosslinking agent, a porogenic solvent and an initiator inside a microchannel. For example, a polymerization mixture containing 18% (Wt) butyl, octyl or lauryl acrylate, 12% (Wt) ethylene glycol dimethacrylate (EDMA), 69.5% (Wt) methanol and 2-propanol (porogens), and 0.5% (Wt) benzoin methyl ether (photoinitiator) can be added to the microchannel and exposed to an 8 W ultraviolet-light at 365 nm to form a hydrophobic polymer monolith within the microchannel. The polymerization can be limited to only those portions of the channel that are exposed to ultraviolet-light, i.e., those portions of the channel that are not masked to prevent exposure of ultraviolet-light to the polymerization mixture. The functionalized porous polymer monolith is typically bonded to the microstructure and/or substrate.

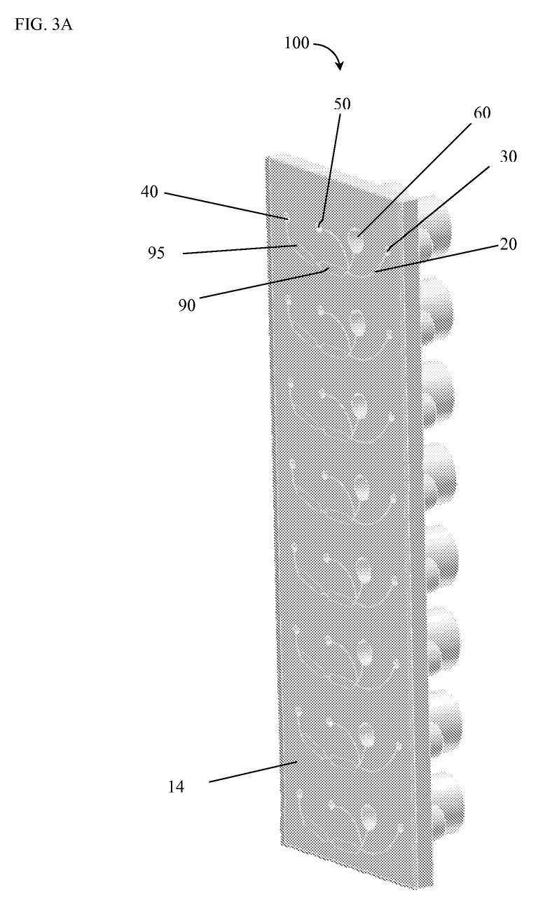

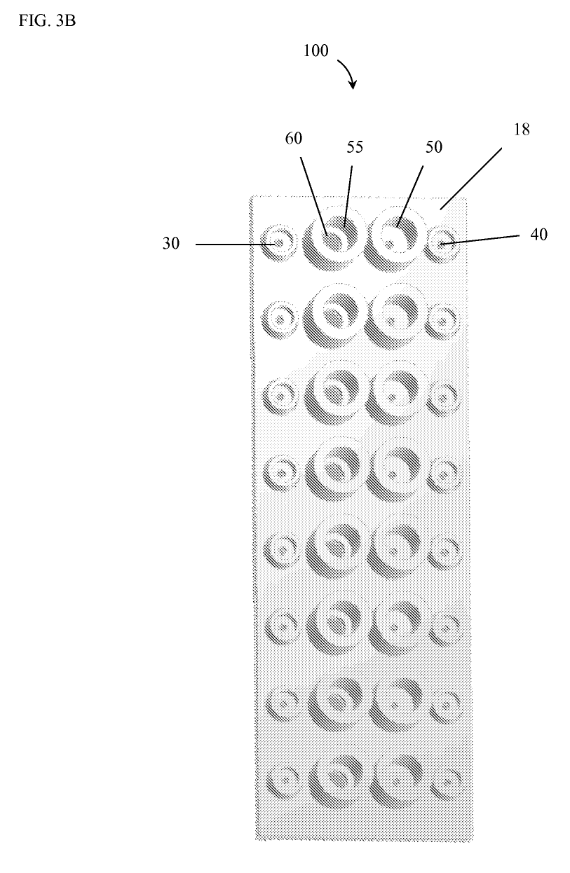

Referring to FIGS. 3A and 3B, in further embodiments, the microfluidic electroelution modules 10 can comprise a microfluidic chip 100 formed from a base substrate 14 and a cover substrate 18. The microfluidic chip 100 can generally comprise a channel 20 having an inlet 30, an outlet 40, a receptacle 60, a first port 60 and a second port 50, a first reservoir 55, and optionally, a microchamber 90 and/or a sorbent material 95. The microfluidic chip 100 can further comprise a plurality of separate channels 20 each having an inlet 30, an outlet 40, a receptacle 60, a first port 60 and a second port 50, a first reservoir 55, and optionally, a microchamber 90 and/or a sorbent material 95, for performing electroelution on a plurality of separate sample simultaneously. The microfluidic chips 100 work in generally the same manner as the microfluidic electroelution modules 10 described above. In further embodiments, the microfluidic chips 100 can have a manifold (not shown) having a first reservoir cover (not shown) associated with a first electrode 70 and an second reservoir cover (not shown) associated with a second electrode 80 for enclosing the first and second ports, respectively, and associating the electrodes 70, 80 in fluid communication with the channel 20. The electrodes 70, 80 can be carried by the manifold (not shown).

Referring to FIG. 1, embodiments of methods of electroelution with sample collection decoupled from the electrophoretic field can generally comprise providing a first fluid pathway H in fluid communication with a second fluid pathway J, associating a sample having at least one macromolecule species of interest with the first fluid pathway H, e.g., positioning a gel spot (not shown) containing the species of interest in the receptacle 60, providing an elution liquid in the first H and second J fluid pathways, creating an electrophoretic field in the first fluid pathway H, electrophoretically separating the species of interest from the sample by the electrophoretic field, and causing the species of interest to flow from the first fluid pathway H toward the second fluid pathway J by using a flow restricting feature and/or a flow enhancing feature that encourage the species of interest to flow from the first fluid pathway H toward the second fluid pathway J. The electrophoretic field can be created by positioning the sample intermediate a pair of electrodes associated with the first fluid pathway. The electroeluted species can be caused to flow into the second fluid pathway J by using a flow restricting feature at a junction G of the first H and second J fluid pathways, e.g., branch channel 22, and/or a flow enhancing feature in the second fluid pathway J, e.g., microchamber 90. The flow restricting features and flow enhancing features can be fluid flow, osmotic, gravitational, hydrodynamic, pressure gradient, or capillary action.

In still further embodiments, the method of electroelution can further comprise collecting the electroeluted species on a sorbent material 95, e.g., a monolith, packed bed, etc., in the second fluid pathway J, e.g., microchamber 95. The collected species on the sorbent material 95 can be further processed, e.g., rinsing, desalting, purifying, and/or concentrating. The collected species can be removed from the sorbent material 95, e.g., flowing a second elution liquid in the channel 20 to elute the collected species from the sorbent material 95. The method of removing the collected species from the sorbent material 95 can be optimized, e.g., providing fluid undulation to create vertical assistance mixing. In embodiments in which the channel 20 is formed from a conductive material, e.g., glass, the method can further comprise coating the first and second fluid pathways with a nonconductive coating to provided a neutral or near-neutral surface change and reduce bulk electroosmotic flow.

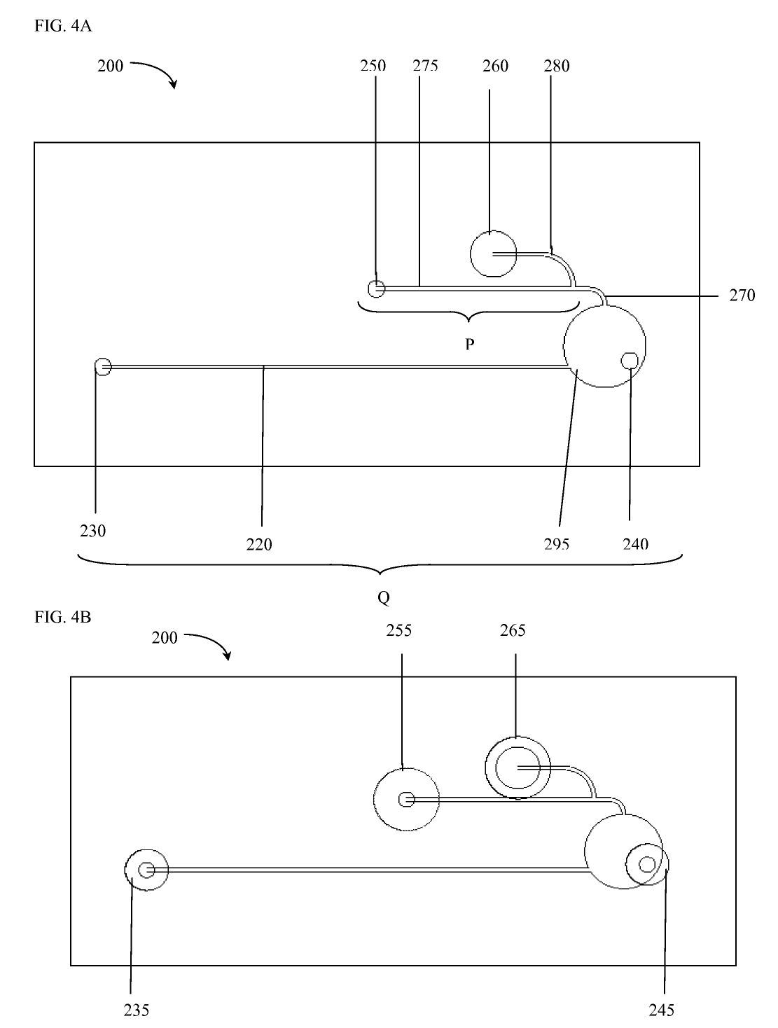

Referring to FIGS. 4A and 4B, a microfluidic module 200 for electroelution can generally comprise a channel 220 having a first fluid pathway P in fluid communication with a second fluid pathway Q, the first fluid pathway P comprising a first port 260 in fluid communication with a second port 250, and a receptacle (not shown) adapted to receive therein a sample (not shown) containing at least one macromolecule species of interest, the receptacle in fluid communication with the first port 260, the second fluid pathway Q comprising an inlet 230 in fluid communication with an outlet 240, wherein the first port 260 is associated with a first electrode (not shown) and the second port 250 is associated with a second electrode (not shown) such that the electrodes will create an electrophoretic field across the receptacle when fluid is present in the channel 220 and power is applied to the electrodes, wherein the channel 220 is configured to create a pressure drop from the first fluid pathway P towards the second fluid pathway Q when fluid is present in the channel 220, and wherein the pressure drop encourages the electroeluted species of interest to flow from the first fluid pathway P towards the second fluid pathway Q. In further embodiments, the microfluidic module 200 can comprise at least one of a first reservoir 265 in fluid communication with the first port 260, a second reservoir 255 in fluid communication with the second port 250, a third reservoir 245 in fluid communication with the outlet 240, and a fourth reservoir 235 in fluid communication with the inlet 230. A pressure drop can be created from the first fluid pathway P towards the second fluid pathway Q by using flow enhancing features and/or flow discouraging features. In some embodiments, the first reservoir 265 can further comprise the receptacle, and the channel 220 can be formed from a nonconductive substrate or a conductive substrate with a substantially nonconductive coating.

The pressure drop may be provided by using a column of liquid in fluid communication with the first fluid pathway P having a height greater than a column of liquid, if any, above the second fluid pathway Q. In embodiments of microfluidic modules 200 and chips 300, the liquid column height of the reservoirs in the first fluid pathway, i.e., first 265 and second 255 reservoirs, can be increased above the first port 260 and second port 250, respectively, and/or the liquid column height of the reservoirs in the second fluid pathway, i.e., third 245 and fourth 235 reservoirs, can be decreased above the outlet 240 and inlet 230, respectively. For example, the pressure drop can be created by the relatively large volumes and column height of fluid in the reservoirs in the first fluid pathway 255, 265 compared to the volume and column height of fluid in the outlet reservoir 245.

In still further embodiments, the second fluid pathway Q can comprise at least one microchamber 295 intermediate the first fluid pathway P and the outlet 240, and a first channel segment 270 intermediate the first fluid pathway P and the microchamber 295. The first fluid pathway P can further comprise a second channel segment 275 intermediate the second port 250 and the first channel segment 270, and a third channel segment 280 intermediate the first port 260 and the first channel segment 270.

In addition, the engineering of the microstructures can be optimized to increase the pressure drop from the first fluid pathway P towards the second fluid pathway Q. For example, the length of the first channel segment 270 can be decreased and the length of the second 275 and third 280 channel segments can be increased. In further embodiments, the magnitude of the pressure drop can be increased by increasing the radius or cross-sectional dimensions of the microchamber 295 and first channel segment 270 and/or decreasing the radius or cross-sectional dimensions of the second 275 and third 280 channel segments. Although the engineering of the microfluidic structures can be optimized to increase the magnitude of the pressure drop from the first fluid pathway P towards the second fluid pathway Q, the pressure drop would be greatly diminished without the presence of the reservoirs 245, 255, and 265. The pressure drop may also be provided by any other means of applying pressure, electroendoosmotic forces, gravitational forces, and surface tension forces.

In yet further embodiments, the microfluidic module 200 can comprise a sorbent material (not shown) in the second fluid pathway Q, e.g., a monolith or packed bed. In some embodiments, the monolith can be a porous polymer monolith formed integrally in the second fluid pathway Q, e.g., the monolith can be a functionalized porous polymer monolith formed integrally in the microchamber 295 in the second fluid pathway Q. The pressure drop from the first fluid pathway P towards the second fluid pathway Q may be disrupted if the sorbent material fills a significant portion of the microchamber 295 and produces back pressure. In the devices of the present invention, the sorbent material can fill between about 5% and 90%, more preferably-between about 10% and 75%, and often between about 25% and 50%.

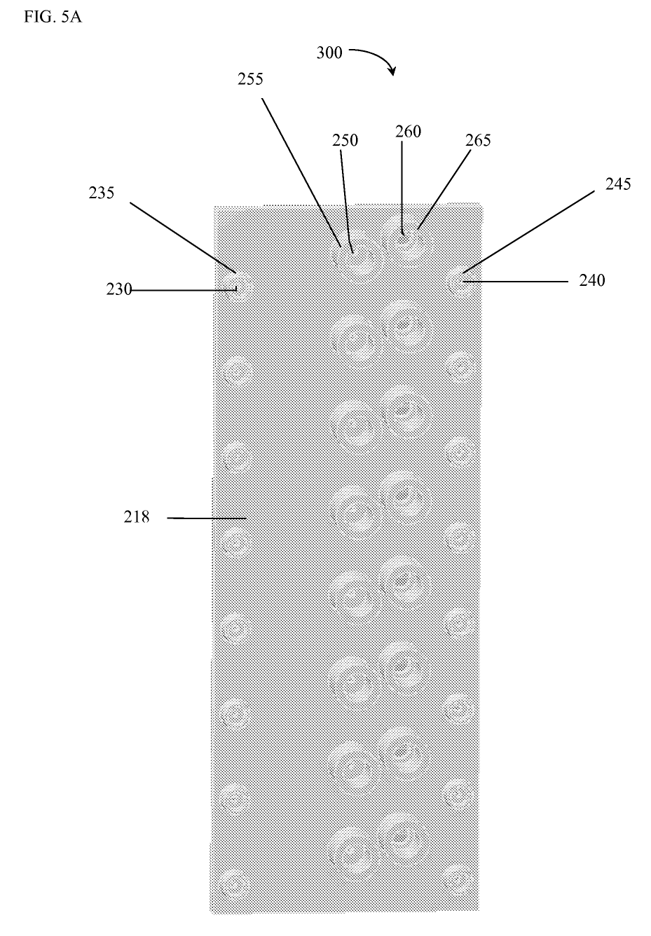

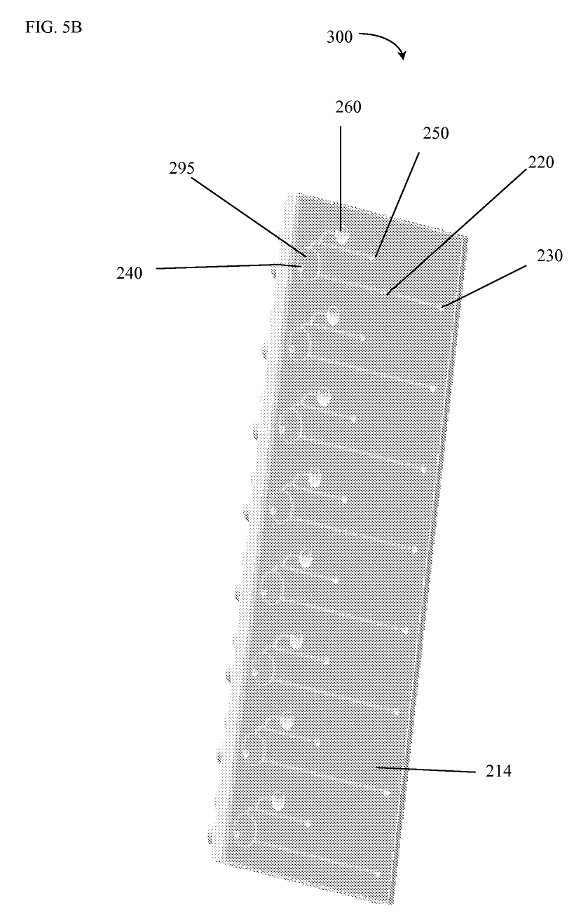

Referring to FIGS. 5A and 5B, in other embodiments, the microfluidic module 200 can further comprise a microfluidic device 300 having a plurality of the channels 220 and a plurality of the reservoirs 235, 245, 255, and 265, and optionally, a sorbent material in the second fluid pathway Q of each channel 220. The microfluidic device 300 can further comprise a manifold (not shown) for sealing the reservoirs 235, 245, 255, and 265 and associating the electrodes (not shown) with the ports 250, 260, respectively, i.e., the manifold can carry the electrodes.

Referring to FIGS. 4 and 5, a method of electroelution can generally comprise providing a first fluid pathway P in fluid communication with a second fluid pathway Q, associating a sample (not shown) having at least one macromolecule species of interest with the first fluid pathway P, providing an elution liquid in the first P and second fluid pathways Q, creating a pressure drop from the first fluid pathway P towards the second fluid pathway Q, creating an electrophoretic field in the first fluid pathway P, electrophoretically separating the species from the sample by the electrophoretic field, and wherein the pressure drop causes the species to flow from the first fluid pathway P toward second fluid pathway Q. In further embodiments, the method can further comprise the step of collecting the species on a sorbent material (not shown) in the second fluid pathway Q. After collecting the species on the sorbent material, the species can be further processed, e.g., rinsing, desalting, purifying, and/or concentrating, and/or removed from the sorbent material, e.g., flowing a second elution liquid through the second fluid pathway Q. The removal of the species from the sorbent material can be optimized, e.g., providing fluid undulation to create vertical assistance mixing.

Referring to FIGS. 1-2, the microfluidic electroelution modules 100 and chips 200 utilizing an extraction and/or recovery scheme that is decoupled from the electrophoretic field and associated hydrodynamic sample processing can be generally used as follows. After a sample containing proteins or other macromolecule species of interest, e.g., nucleic acids, antigens, antibodies, or any combination thereof, is separated using an acrylamide gel, e.g., polyacrylamide and/or agarose matrices, the proteins can be visualized using a non-fixing stain, e.g., modified Coomassie or SYPRO orange. Fixing stains can also be used, but recovery is less efficient because the macromolecule sample can be precipitated in the gel matrix. The protein bands can be excised from the gel matrix using a scalpel or tubular spot picker. The sample or the gel band containing the proteins to be electroeluted can be positioned in the receptacle 60. A syringe, peristaltic pump, or other solvent delivery system (not shown) can be connected to the inlet 30 by a first bridging fluidic connector (not shown). A collection system (not shown), such as a waste vial rack or a sample collection vial rack, can be connected to the outlet 40 by a second bridging fluidic connector (not shown). Next, the microfluidic modules 10 can be primed with an elution liquid, e.g., a buffer solution, at a low flow rate. The receptacle 60, second port 50, and first reservoir 55 can be filled with the elution liquid via a pipette. The elution liquid will fill the channel 20 via capillary action. By closing the manifold (not shown), the first 70 and second 80 electrodes can be secured in the elution liquid and the reservoirs can be fluidically sealed against air introduction. A safety lid (not shown) can be closed over the microfluidic modules 10 and the waste vial rack lid (not shown).

When a constant voltage of 100-2500V is applied to the microfluidic module 10, typically for less than one hour, the electric current created through the elution liquid establishes an electric field across the gel spot. The electrophoretic field is substantially confined within the first fluid pathway H such that the second fluid pathway J is decoupled from the electrophoretic field. The electroelution voltages drive the proteins from the gel spot into the elution liquid. The principles of gel electrophoresis govern the movement of the proteins out of the gel spot. However, the flow restricting and/or flow enhancing features encourage the electroeluted proteins to migrate toward the outlet 40 instead of the second electrode 80, i.e., the second port 50. After the voltage is turned off, the introduction of hydrodynamic flow of the buffer solution causes the electroeluted proteins to flow onto the sorbent material 95, e.g., a monolith and packed bed. The waste vial rack (not shown) can be removed and replaced with a sample collection vial rack (not shown). A second elution liquid can be introduced at the inlet 30 to elute the proteins collected on the sorbent material 95 into the sample collection vial. Finally, the sample vials can be removed and the proteins can be subjected to subsequent identification and analysis.

Referring to FIGS. 4 and 5, the microfluidic electroelution modules 200 and chips 300 utilizing an extraction and/or recovery scheme that is decoupled from the electrophoretic field and associated hydrodynamic sample processing can be generally used as described above. The sample containing proteins or other macromolecule species of interest can be generally prepared as described above. When a constant voltage of 100-2500V is applied to the microfluidic module 200, typically for less than one hour, the electric current created through the elution liquid establishes an electric field across the receptacle. The electrophoretic field is substantially confined within the first fluid pathway P such that the second fluid pathway Q is decoupled from the electrophoretic field. The electroelution voltages drive the proteins from the gel spot into the elution liquid. The principles of gel electrophoresis govern the movement of the proteins out of the gel spot.

In addition to the general principles previously described, the pressure drop encourages the electroeluted proteins to migrate toward the second fluid pathway Q instead of the second electrode. The electroeluted proteins can be collected on a sorbent material, e.g., a monolith or packed bed. After the voltage is turned off, the proteins collected on the sorbent material can be removed or eluted from the sorbent material and/or subjected to further processing. The waste vial rack (not shown) can be removed and replaced with a sample collection vial rack (not shown). A solvent delivery system can deliver a second elution liquid at the inlet 230 to elute the proteins collected on the sorbent material into the sample collection vial. Finally, the sample vials can be removed and the proteins can be subjected to subsequent identification and analysis.

The movement of the proteins and other macromolecules in microfluidic electroelution modules and chips is based on the electrophoretic mobility of the proteins in the sample and the principles of capillary electrophoresis that govern the movement and behavior of free proteins in the channel post-electroelution. Referring to FIGS. 1-3, embodiments of the microfluidic electroelution modules 10 and chips 100, the electrophoretic movement of the proteins from the receptacle 60 toward intersection K is caused by the electrokinetic attraction of the proteins to the second electrode 80 at the second port 50. The behavior exhibited by the proteins in the first fluid pathway H can be described as the sum of the forces experienced by the proteins within the first fluid pathway H, as shown in Equations 1 and 2,

F_{Total}=F₁+F₂+F₃ . . . etc. (1)

Here,

F_{Total}=F_{E}+F_{HD}+F_{HS} (2)

where, F_{E}≡electrokinetic force, which is a sum of the forces on the protein due to its inherent electrophoretic mobility and the forces of bulk electroosmotic flow within the fluid pathway, F_{HD}≡hydrodynamic force, and F_{HS}≡hydrostatic force.

In embodiments of the microfluidic electroelution modules 10 and chips 100, the substrate may be designed such that by chemical treatment or natural properties it has a near-neutral or neutral surface charge, thereby eliminating bulk electroosmotic flow (EOF). If a negative surface charge is present on the substrate, then a bulk EOF flow will be established towards the first electrode 70; conversely, if a positive surface charge is present on the substrate, then a bulk EOF flow will be established towards the second electrode 80. Since EOF is near zero in the fluidic channel network H, F_{E} can be approximated by the electrophoretic force on the proteins as produced by their inherent electrophoretic mobilities in the applied electric field. Therefore, in the case of conductive or semi-conductive substrates, the microstructures should be chemically treated with an insulating layer.

The hydrodynamic force is due to back pressure from the channel 20 size restrictions and the solvent delivery system connected to the inlet 30. The hydrostatic force is due to the relatively large volumes of fluid and column heights of buffer associated with the second port 50 and first reservoir 55 as compared to the volume and column height of the outlet reservoir (not shown). Prior to intersection K, F_{E} dominates Equation 2 such that F_{Total}≈F_{E}. The microfluidic structures on the device 10, in particular, the flow restricting and/or flow enhancing features, can be designed such that the hydrodynamic force balances the hydrostatic force, i.e., the vector sum of F_{HS} and F_{HD} is approximately zero. However, after intersection K, the proteins experience the new unbalanced forces F_{HS} and F_{HD} deriving from both directions of the second port 50 and first reservoir 55 such that F_{HD}+F_{HS}>>F_{E}.

At intersection L, the proteins experience a strong hydrodynamic force that inhibits movement of the proteins toward the inlet 30. The solvent delivery system connected to the inlet 30 provides strong hydrodynamic resistance such that the vector sums of all forces, F_{Total}, experienced by the proteins in the channel 20 directs the movement of the proteins past intersection M and into the microchamber 90. Therefore, electroeluted and free sample proteins are directed from the receptacle 60, past intersections K and L, into the microchamber 90, and toward the sorbent material 95. A low hydrodynamic flow can be introduced at intersection L via a syringe to further assist the movement of the proteins toward and onto the sorbent material 95.

The movement of proteins and other macromolecules in microfluidic modules 200 and chips 300 are governed by similar principles of capillary electrophoresis as described above. Referring to FIGS. 4-5, embodiments of microfluidic modules 200 and chips 300, in addition to these general principles, can be engineered and configured to create a pressure drop from the first fluid pathway P towards the second fluid pathway Q that causes the electroeluted species to flow from the first fluid pathway P toward the second fluid pathway Q. The pressure drop should be larger than the electrophoretic field to cause the electroeluted species to flow from the electrophoretic field toward the second fluid pathway Q. The magnitude of the pressure drop between various sections of the microchannel can be determined by calculating the hydrostatic pressure along each section of microchannel. The hydrostatic pressure along the channel 220 can be described by Equation 3

P=ρ·g·h+Pₐ (3)

where, P≡hydrostatic pressure, ρ≡liquid density, g≡gravitational acceleration, h≡height of liquid relative to the fluid within channel, and Pₐ≡atmospheric pressure.

The dynamics of fluid movement in microfluidic modules 200 and chips 300 are generally governed by the diameter and length of the microchannel structure according to Poiseuille's Law. The magnitude of the pressure drop along each section of the channel 220 can be estimated using Poiseuille's Law given in Equation 4

$$Q = \frac{Δ P \cdot Π \cdot {r}^{4}}{8 \cdot η \cdot L} \qquad ( 4 )$$

where, Q≡volumetric flow rate, ΔP≡pressure drop, Π≡pi, r≡radius of channel, η≡viscosity, L≡length of channel. Poiseuille's equation is only strictly valid for circular flow channels. The channels of this invention can have cross-sections of various shapes, e.g., circular, wedge-shaped and substantially rectangular. Thus, in embodiments with non-circular cross-sections, Poiseuille's equation can be considered only as an approximate relation between the variables represented. According to Poiseuille's equation, the pressure drop is directly proportional to the length of the microchannel structure and the radius or diameter of the microchannel structure has a fourth power effect on the pressure drop. Therefore, the pressure drop can be increased by, e.g., decreasing the length of the first channel segment 270, increasing the length of the second 275 and third 280 channel segments, increasing the radius or cross-sectional dimensions of the microchamber 295 and first channel segment 270, and/or decreasing the radius or cross-sectional dimensions of the second 275 and third 280 channel segments.

Therefore, what has been described above includes exemplary embodiments of microfluidic electroelution modules, devices, and processes utilizing an extraction and/or a collection and recovery scheme that is decoupled from the electrophoretic field. It is, of course, not possible to describe every conceivable combination of components or methodologies for purposes of this description, but one of ordinary skill in the art may recognize that further combinations and permutations are possible in light of the overall teaching of this disclosure. Accordingly, the description provided herein is intended to be illustrative only, and should be considered to embrace any and all alterations, modifications, and/or variations that fall within the spirit and scope of the appended claims.

What is claimed is:

1. A microfluidic module for electroelution with sample collection decoupled from the electrophoretic field, said microfluidic module comprising:
(a) a channel having an inlet and an outlet;
(b) a receptacle in fluid communication with said channel intermediate said inlet and said outlet;
(c) a first port and a second port in fluid communication with said channel, said second port positioned intermediate said receptacle and said outlet, said receptacle located between said first and second ports, said first and second ports adapted to receive first and second electrodes, respectively, such that said first and second electrodes will complete an electrical circuit when fluid is present in said channel to create an electrophoretic field across said receptacle when power is applied to said electrodes; and
(d) at least one of a flow restricting feature and a flow enhancing feature in fluid communication with said channel intermediate said second port and said outlet such that fluid flow in said channel towards said outlet is encouraged and fluid flow in said channel towards said second port is discouraged.

2. The microfluidic module of claim 1 wherein said flow restricting feature further comprises a branch channel connecting said second port to said channel to further discourage fluid flow towards said second port.

3. The microfluidic module of claim 2 wherein said flow enhancing feature further comprises a microchamber provided in said channel intermediate said branch channel and said outlet such that fluid flow towards said outlet is encouraged.

4. The microfluidic module of claim 1 further comprising a first reservoir associated with said receptacle, said first reservoir in fluid communication with said first port.

5. The microfluidic module of claim 1 further comprising a sorbent material in said channel intermediate said second port and said outlet such that said sorbent material is decoupled from said electrophoretic field created between said electrodes.

6. The microfluidic module of claim 5 wherein said sorbent material is a monolith or a packed bed.

7. The microfluidic module of claim 5 wherein said sorbent material is a functionalized porous polymer monolith formed integrally in said channel.

8. The microfluidic module of claim 1 wherein said microfluidic module further comprises a microfluidic chip.

9. The microfluidic module of claim 8 wherein said channel further comprises a sorbent material decoupled from said electrophoretic field created between said electrodes.

10. The microfluidic module of claim 8 further comprising a plurality of said channels each having said receptacle and said first and second ports for separately performing electroelution with sample collection decoupled from said electrophoretic field for a plurality of samples.

11. The microfluidic module of claim 10 wherein each of said plurality of said channels further comprise a sorbent material decoupled from said electrophoretic field created between said electrodes.

12. The microfluidic module of claim 11 further comprising a manifold having first and second electrodes, a first cover for said first port and a second cover for said second port, said first and second covers for enclosing said first and second electrodes in fluid communication with said channel.

13. A method of electroelution with sample collection decoupled from the electrophoretic field, said method comprising:
(a) providing a first fluid pathway in fluid communication with a second fluid pathway;
(b) associating a sample having at least one macromolecule species of interest with said first fluid pathway;
(c) providing an elution liquid in said first and second fluid pathways;
(d) creating an electrophoretic field in said first fluid pathway;
(e) electrophoretically separating said species from said sample by said electrophoretic field; and
(f) causing said species to flow from said first fluid pathway toward said second fluid pathway by using at least one of a flow restricting feature and a flow enhancing feature that encourage said species to flow toward said second fluid pathway.

14. The method of claim 13 wherein said at least one of a flow restricting feature and a flow enhancing feature is fluid flow, osmotic, gravitational, hydrodynamic, pressure gradient, or capillary action.

15. The method from claim 13 further comprising the step of collecting said species on a sorbent material in said second fluid pathway.

16. The method from claim 15 further comprising the step of removing said species collected on said sorbent material.

17. The method from claim 16 further comprising the step of optimizing said removal of said species from said sorbent material.

18. The method from claim 17 wherein said optimizing further comprises providing fluid undulation to create vertical assistance mixing.

19. The method of claim 16 wherein said removing further comprises flowing a second elution liquid through said second fluid pathway that causes said species collected on said sorbent material to elute from said sorbent material.

20. The method from claim 15 further comprising the step of processing said species collected on said sorbent material.

21. The method of claim 20 wherein said processing further comprises at least one of rinsing, desalting, purifying, and concentrating.

22. A microfluidic module for electroelution with sample collection decoupled from the electrophoretic field, said microfluidic module comprising:
(a) a channel having a first fluid pathway in fluid communication with a second fluid pathway;
(b) said first fluid pathway comprising a first port in fluid communication with a second port, and a receptacle adapted to receive therein a sample containing at least one macromolecule species of interest, said receptacle positioned intermediate said first and second ports;
(c) said second fluid pathway comprising an inlet in fluid communication with an outlet;
(d) wherein said first port can be associated with a first electrode and said second port can be associated with a second electrode such that said first and second electrodes will create an electrophoretic field across said receptacle when said first and second electrodes and fluid are present in said channel and power is applied to said electrodes;
(e) wherein said channel is configured to create a pressure drop from said first fluid pathway towards said second fluid pathway when fluid is present in said channel; and
(f) wherein said pressure drop encourages said species of interest to flow from said first fluid pathway toward said second fluid pathway.

23. The microfluidic module of claim 22 further comprising at least one of a first reservoir in fluid communication with said first port, a second reservoir in fluid communication with said second port, a third reservoir in fluid communication with said outlet, and a fourth reservoir in fluid communication with said inlet.

24. The microfluidic module of claim 23 wherein said first and second reservoirs have a combined volume greater than a combined volume of said third and fourth reservoirs such that when fluid is present a pressure drop is created from said first fluid pathway towards said second fluid pathway.

25. The microfluidic module of claim 23 wherein said first reservoir further comprises said receptacle.

26. The microfluidic module of claim 22 wherein said second fluid pathway further comprises at least one microchamber intermediate said first fluid pathway and said outlet.

27. The microfluidic module of claim 26 wherein said second fluid pathway further comprises a first channel segment intermediate said first fluid pathway and said at least one microchamber.

28. The microfluidic module of claim 27 wherein said first fluid pathway further comprises a second channel segment intermediate said second port and said first channel segment.

29. The microfluidic module of claim 28 further comprising a third channel segment intermediate said first port and said first channel segment.

30. The microfluidic module of claim 24 further comprising a sorbent material in said second fluid pathway.

31. The microfluidic module of claim 30 wherein said sorbent material is a monolith or packed bed.

32. The microfluidic module of claim 31 wherein said monolith is a porous polymer monolith formed integrally in said second fluid pathway.

33. The microfluidic module of claim 31 wherein said monolith is a functionalized porous polymer monolith formed integrally in at least one microchamber in said second fluid pathway.

34. The microfluidic module of claim 24 wherein said channel is formed from a nonconductive substrate.

35. The microfluidic module of claim 24 wherein said channel is formed from a conductive substrate having a substantially nonconductive coating.

36. The microfluidic module of claim 25 further comprising a manifold for sealing said reservoirs and associating said electrodes with said ports.

37. The microfluidic module of claim 36 wherein said manifold further comprises said first and second electrodes, a first cover for said first port and a second cover for said second port, said first and second covers for enclosing said first and second electrodes in fluid communication with said channel.

38. The microfluidic module of claim 24 further comprising a microfluidic device having a plurality of said channels and a plurality of said reservoirs.

39. The microfluidic device of claim 38 further comprising a sorbent material in said second fluid pathway of said plurality of said channels.

40. A method of electroelution with sample collection decoupled from the electrophoretic field, said method comprising:
(a) providing a first fluid pathway in fluid communication with a second fluid pathway;
(b) associating a sample having at least one macromolecule species of interest with said first fluid pathway;
(c) providing an elution liquid in said first and second fluid pathways;
(d) creating a pressure drop from said first fluid pathway towards said second fluid pathway;
(e) creating an electrophoretic field in said first fluid pathway;
(f) electrophoretically separating said species from said sample by said electrophoretic field; and
(g) wherein said pressure drop causes said species to flow from said first fluid pathway toward said second fluid pathway.

41. The method from claim 40 further comprising the step of collecting said species on a sorbent material in said second fluid pathway.

42. The method from claim 41 further comprising the step of removing said species collected on said sorbent material.

43. The method from claim 42 wherein said removing said species collected on said sorbent material further comprises flowing a second elution liquid through said second fluid pathway.

44. The method from claim 42 further comprising the step of optimizing said removal of said species collected on said sorbent material.

45. The method from claim 44 wherein said optimizing further comprises providing fluid undulation to create vertical assistance mixing.

46. The method from claim 41 further comprising the step of processing said species collected on said sorbent material.

47. The method of claim 46 wherein said processing further comprises at least one of rinsing, desalting, purifying, and concentrating.

48. The method from claim 40 further comprising the step of coating said first and second fluid pathways with a nonconductive coating.
